(19) United States
(12) Patent Application Publication
(10) Pub. No.: US 2006/0105162 A1
(43) Pub. Date: May 18, 2006

(54) Cast iron articles of manufacture and process to reduce outgassing during powder coating of cast iron articles

(75) Inventors: Richard Valentine, Hillsboro, OH (US); Bill Sanders, Richmond Hill, GA (US); David Fredericksen, Palatine, IL (US); Al Suopys, Lindenhurst, IL (US); Michael Starozhitsky, Long Grove, IL (US)

Correspondence Address: BANNER & WITCOFF, LTD., TEN SOUTH WACKER DRIVE, SUITE 3000, CHICAGO, IL, 60606, US

(73) Assignee: Illinois Tool Works, Inc., Glenview, IL (US)

(21) Appl. No.: 11/074,553

(22) Filed: Mar. 8, 2005

Related U.S. Application Data
(60) Provisional application No. 60/629,250, filed on Nov. 18, 2004.

(51) Int. Cl. B32B 15/08; C22C 37/00

(52) U.S. Cl. 428/339; 428/457; 148/543; 420/26

(57) ABSTRACT

Grey cast iron is inoculated with about 0.40 to 1.50 weight percent copper in order to generate a pearlite surface layer which will prevent undesired outgassing during subsequent high temperature (350° F.) powder coating processing with a hybrid organic powder.

### BACKGROUND OF THE INVENTION

In a principal aspect the present invention relates to cast iron articles of manufacture and methods for manufacturing such articles wherein the articles may be coated with, for example, a polymeric coating material. Such articles are especially useful in the food processing industry as component parts of food processing machinery.

Cast iron, in particular grey cast iron, is generally described in Metals Handbook, Desk Edition, Second Edition, Copyright 1998 by ASM International, at pages 307-324, particularly pages 309-314, all of which are incorporated herewith by reference. Formulations, characteristics and microstructure of cast irons and, in particular, grey cast irons are described. Grey cast iron parts or articles of manufacture incorporating various microstructures are used, among other purposes, for the manufacture of machines including machinery utilized in the food processing industry, for example, mixing equipment, grinding equipment and the like. Typically, for food processing equipment, it is desirable to cast the component part, then machine or otherwise work the part or article and then coat the article with an appropriate coating material so that it can be used in a food processing environment. Various polymeric and other coatings or plating may be used.

In the manufacture of such machines and machine parts or articles, a processing step employed prior to coating typically includes an annealing step to effect release of moisture and outgassing. However, it has been observed that grey cast irons of the type referenced in the above literature, during a subsequent high temperature powder coating step, may further outgas thereby destroying or impairing the integrity of the coating. Altering the temperatures and sequence of steps and other remedies which would avoid such a result have been generally unsuccessful. Thus, there developed a need to provide a methodology as well as a microstructure and formulation for grey cast iron, which would enhance the ability to coat the article with an organic powder coating, for example, without adverse effects resulting from outgassing of the casting during a high temperature coating step.

Any such process would necessarily result in a generally uniform coating that completely covers a part or article without pits, fissures or other undesirable anomalies caused by outgassing during a coating process.

### SUMMARY OF THE INVENTION

Briefly, the present invention comprises the discovery of the formulation and processing steps considered appropriate and necessary to substantially eliminate the problem of outgassing grey cast iron castings at higher temperatures associated with a coating operation. To achieve the desired results, small amounts of copper in the range of 0.40-1.5 weight percent are incorporated in the cast iron melt. The addition of copper is preferably in the range of 0.40 to 0.75 weight percent. Additional silicate may also be included in the starting melt in the range of about 0.30 weight percent through inoculation with various additives. A resultant and desirable microstructure comprises an outer boundary layer on the cast part or article of pearlite in the range of at least about 3 mils, though the entire microstructure may be generally pearlitic. Importantly, however, the boundary layer has a pearlite structure. A hypothesis is that the pearlite effectively binds any residual carbon in the casting and further provides a boundary layer through which outgassing may not penetrate even at higher temperatures in the range of 350° F. or thereabouts associated with a powder coating operation. As a result, there is diminished or no outgassing to cause anomalies, fissures, cracks or other undesirable formations in the powder coating.

In examples of the invention, a powder coating, termed a hybrid organic powder coating is applied to the casting. It may be applied through electrostatic processing means. Such a coating is typically and generally non-toxic. However, various coatings may be utilized in the practice of the invention including those having potentially toxic as well as non-toxic attributes.

The processing steps in the manufacture of such articles includes preparation of a cast iron melt with inoculants including copper in the form of wire or in the form of a copper silicate or in some other copper additive form. The cast iron melt is then cast. In a preferred embodiment, the melt is comprised of a specification or formulation for grey iron castings in accord with ASTM standard A159 microstructure. The casting has a microstructure evaluated in accord with ASTM standard A247 with a ferritic and pearlitic and/or pearlite microstructure. Importantly, the surface layer of the article has a pearlite microstructure. The pearlite microstructure may persist throughout the article, but importantly it is included or incorporated at the boundaries or surface areas of the article of manufacture.

Processing typically includes the further step of machining the article to the extent necessary and otherwise working the article. This is followed by an annealing step which effectively removes moisture and other gas forming materials from the article. Such a step is typically accomplished at a temperature in the range of 350-450° F. Subsequently, a powder coating is applied typically at a temperature in the range of 200-230° F. The coating is then cured at a higher temperature typically, for example, in the range of 300-350° F. The coated part is then cooled to ambient temperature. The temperatures for the various process steps may be varied in accord with the particular powder coating that is being used and with other variables.

Thus, it is an object of the invention to provide an improved cast iron formulation which substantially eliminates or avoids outgassing phenomena at temperatures in the range of 200-400° F. and higher.

It is a further object of the invention to provide a process for the manufacture of an article of grey cast iron wherein the grey cast iron is powder coated with an organic or hybrid organic coating material and wherein during the coating operation there is no outgassing to cause fissures or anomalies in the applied coating material.

Yet a further object of the invention is to provide an inexpensive method for the manufacture of cast iron articles having a powder coating thereon which is not damaged by outgassing phenomena.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a flow chart illustrating steps in the manufacture of an article comprised of grey cast iron wherein the article is coated by an organic coating material in powder form with minimum anomalies created in the coating as a result of outgassing during the coating process;

FIG. 2 is a photomicrograph of a cross section of a coated casting made in accord with the invention;

FIG. 3 is a photomicrograph at 50 magnifications depicting a coated casting wherein outgassing creates an anomaly at the surface of the casting;

FIG. 4 is a photomicrograph similar to FIG. 3 wherein the coated casting exhibits no surface anomaly as a result of outgassing;

FIG. 5 is a photomicrograph of a coated casting wherein a section of the surface of the article of manufacture is depicted at 50 magnifications;

FIG. 6 is a photomicrograph at 50 magnifications illustrating the microstructure of a casting made in accord with the invention;

FIG. 7 is a photomicrograph at 100 magnifications illustrating the surface region of a casting wherein the surface has been ground and the pearlite removed from the surface;

FIG. 8 is a photomicrograph at 500 magnifications depicting a section of the surface in FIG. 7;

FIG. 9 is a photomicrograph at 100 magnifications wherein the surface of the casting has not been ground or otherwise worked and wherein a pearlite phase maintains a boundary layer at the surface to preclude outgassing; and

FIG. 10 is a photomicrograph at 500 magnifications of a section of the photomicrograph of FIG. 9.

### DESCRIPTION OF THE PREFERRED EMBODIMENTS

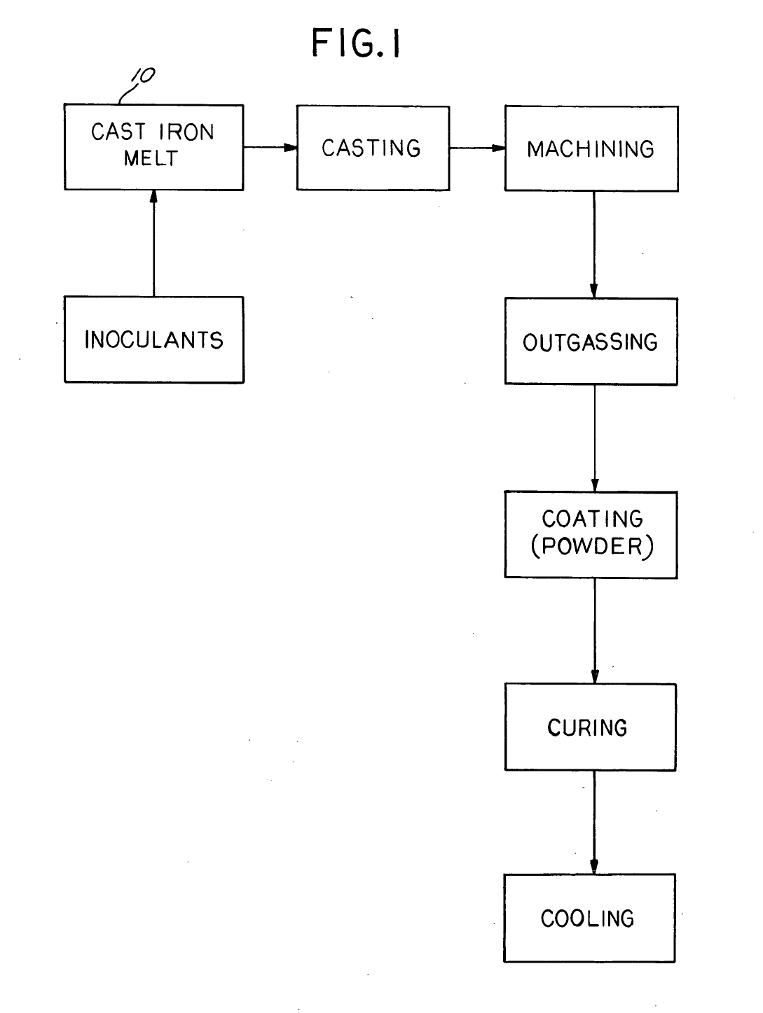

FIG. 1 depicts generally the processing steps to practice the invention. A grey cast iron melt is formulated to include various inoculants or additive materials. Thus, the grey cast iron melt includes copper in the range of about 0.40 to 1.50 weight percent of the melt. Preferably, a silicate is also incorporated in the melt in the range up to about 0.30 weight percent plus or minus 0.20 weight percent. In a preferred embodiment, the range of copper additive is in the amount of 0.40 to about 0.75 weight percent and the silicate additive is in the amount of about 0.30 weight percent. Also, the preferred embodiment comprises the described inoculants or additives in combination with a grey cast iron formulation in accord with ASTM standard A159 having a generally ferrite and pearlite or pearlite microstructure as evaluated by ASTM standard A247.

Thus, the melt is cast so as to be primarily a ferrite and pearlite or pearlite structure. More particularly, the casting should exhibit, at a minimum, an outer layer of pearlite with the remainder of the microstructure being principally ferrite and possibly various other ferrous microstructures. In a preferred embodiment, the casting will typically and preferably include a pearlite outer or surface layer in the range of at least about 3 mils or more. The surface layer of pearlite is an important feature of the invention. Pearlite may, however, persist throughout the microstructure or comprise the microstructure. Most importantly, however, there is a surface layer of pearlite which generally precludes undesirable outgassing particularly during any subsequent high temperature powder coating operation, i.e. exceeding about 200° F.

Subsequent to casting the article of manufacture, the article may be machined. For example, bearing surfaces or the like may be machined or the article may otherwise be worked. Desirably, the working or machining should not eliminate the pearlite boundary layer, particularly in the regions where a coating is to be applied.

Subsequent to machining and/or working, the article or part will in fact, typically be outgassed. This is a step which effectively removes moisture and any surface gases. It should be noted, however, that the pearlite will effectively preclude certain amounts of outgassing inasmuch as it acts as boundary layer to preclude such outgassing. The outgassing step is typically performed at about 400° F., but the range of temperature may vary from 350-400° F. or slightly above 400° F., for example, 450° F. The time required for the outgassing step is typically in the range of about one hour. The time, of course, will vary depending upon the temperature and the mass as well as configuration of the article. Times of 30 minutes to several hours may be used. Moroever, heating for extended periods of time beyond several hours may be used in the present invention. However, in a preferred embodiment the entire article will typically be preheated to about 400° F. for approximately one hour. Other variations and time and temperature may be utilized.

The article or part then is cooled to a temperature in the range of 180-240° F. and, in particular, to about 210° F. During this cooling or subsequent thereto, the article is coated with a powder. The powder is typically an organic powder or hybrid organic powder which, when applied electrostatically or otherwise, is melted and flows to cover the surface of the article or part. One particular type of coating material that has been found useful in the coating process step described is a hybrid organic powder, Product No. EW001Q Silver by AlszoNobel(?). However, the invention is not limited to any particular powder coating. Typically, hybrid organic powders are preferred.

Coating with a powder coating material typically will require only a few minutes of time. The powder flows evenly over the surface of the article, but will not generally generate fissures or anomalies inasmuch as the pearlite boundary layer generally precludes such occurrence. Subsequently, the coating is cured typically in the range of about 300-375° F. and for a time of about 10-15 minutes. Again, the time and temperature are adjustable, depending upon the coating material. In a preferred embodiment, the described coating material set forth above will adhere appropriately upon curing at 325° F. for a period of about 12 minutes. The coated article of manufacture is then cooled to ambient temperature and ready for assembly as a component part of a machine. A coating thickness of about 10 mils or more is preferred.

Various experiments have demonstrated the efficacy of the protocol described and the resultant article of manufacture. As a result, the following specifications comprise representative examples of the formulation of the inoculated grey cast iron in the practice of the invention:

Type 1

Material: Cast Iron per ASTM A159 G1800 w/0.40-0.75% Cu

Microstructure: Per ASTM A247:
Matrix to be Ferritic and Pearlitic; Primarily Type A Graphite; Free of Primary Carbides

Innoculation: Ca bearing Ferro-Silicon, 0.30% min. increase in base Si

Type 2

Material: Cast Iron per ASTM A159 G2500 w/0.40-0.75% Cu

Microstructure: Per ASTM A247:
Matrix to be Pearlitic and Ferritic; Primarily Type A Graphite; Free of Primary Carbides

Innoculation: Ca bearing Ferro-Silicon, 0.30% min. increase in base Si

Type 3

Material: Cast Iron per ASTM A159 G3000 w/0.40-0.75% Cu

Microstructure: Per ASTM A247:
Matrix to be Pearlitic; Primarily Type A Graphite; Free of Primary Carbides

Innoculation: Ca bearing Ferro-Silicon, 0.30% min. increase in base Si

In some embodiments, coating takes place with limited or no preliminary sanding or smoothing. The cast iron articles or parts may be rough after the casting process. Sanding or other smoothing of the articles or parts takes time and resources. In the present invention, in some embodiments, the coating may be applied directly over the rough articles or parts. In a preferred embodiment, the cast iron articles or parts included portions of food ingredient mixers for restaurants or bakeries, including the base, head, bowl support and vertical column. However, the present invention is not limited to such parts and includes other cast iron articles or parts.

In some embodiments the coating that is applied can be thicker than many typical spray coatings. This thickness, in part, allows for fuller coverage of the article or part. In some embodiments, a finish approaching that of an automotive quality finish can be obtained with little or no sanding or smoothing. The thickness of the coating also can enhance the durability of the coating. Moreover, elimination or minimization of sanding or smoothing can diminish the amount of hazardous materials generated.

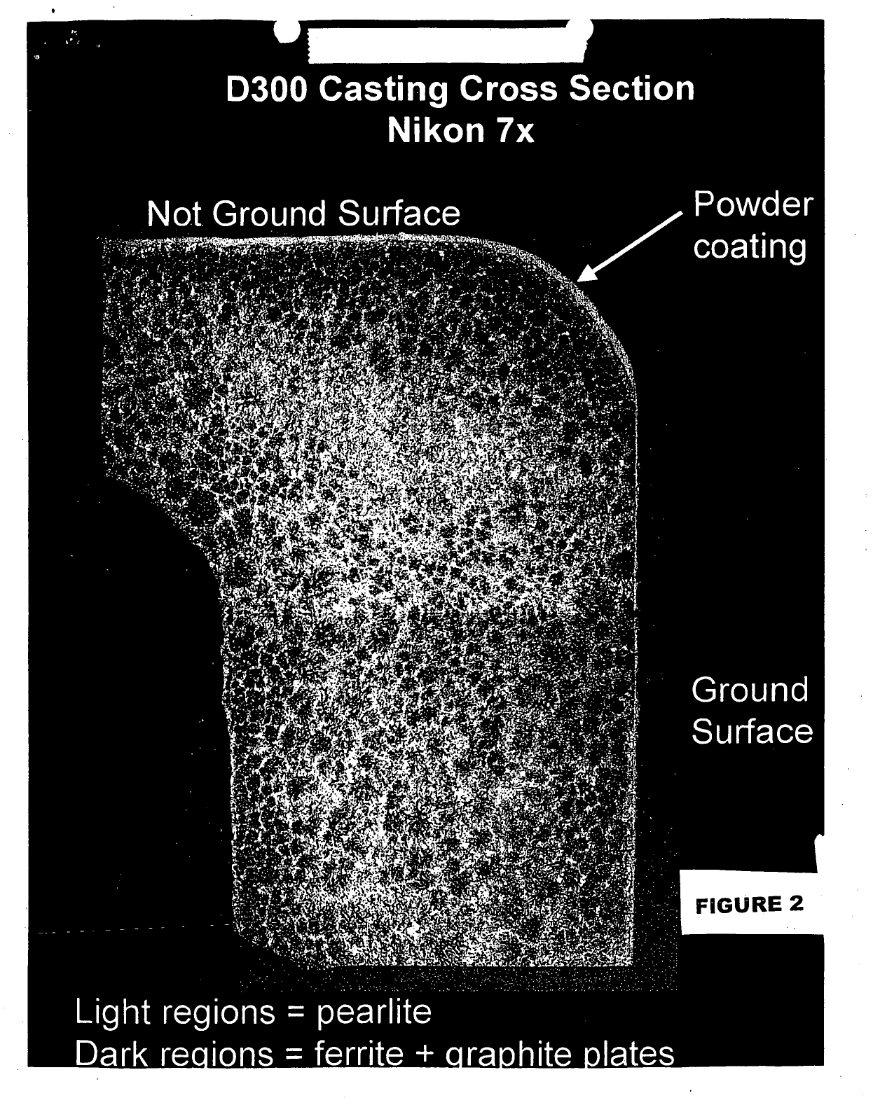

Referring to FIG. 2 there is depicted a coated casting of grey cast iron made in accordance with the invention magnified seven times. The top surface has not been ground or machined. It is powder coated. The lateral side surface has been mechanically ground or altered. Looking at the photomicrograph, the light areas are pearlite whereas the dark areas comprise ferrite material along with graphite plates.

FIGS. 3-10 comprise various additional photomicrographs of the sample of FIG. 2. FIG. 3, for example, shows a fissure in the coating inasmuch as the photomicrograph suggests that the article has been machined to remove the pearlite layer. Thus, the coating applied over the surface fails because of the fissure created by outgassing.

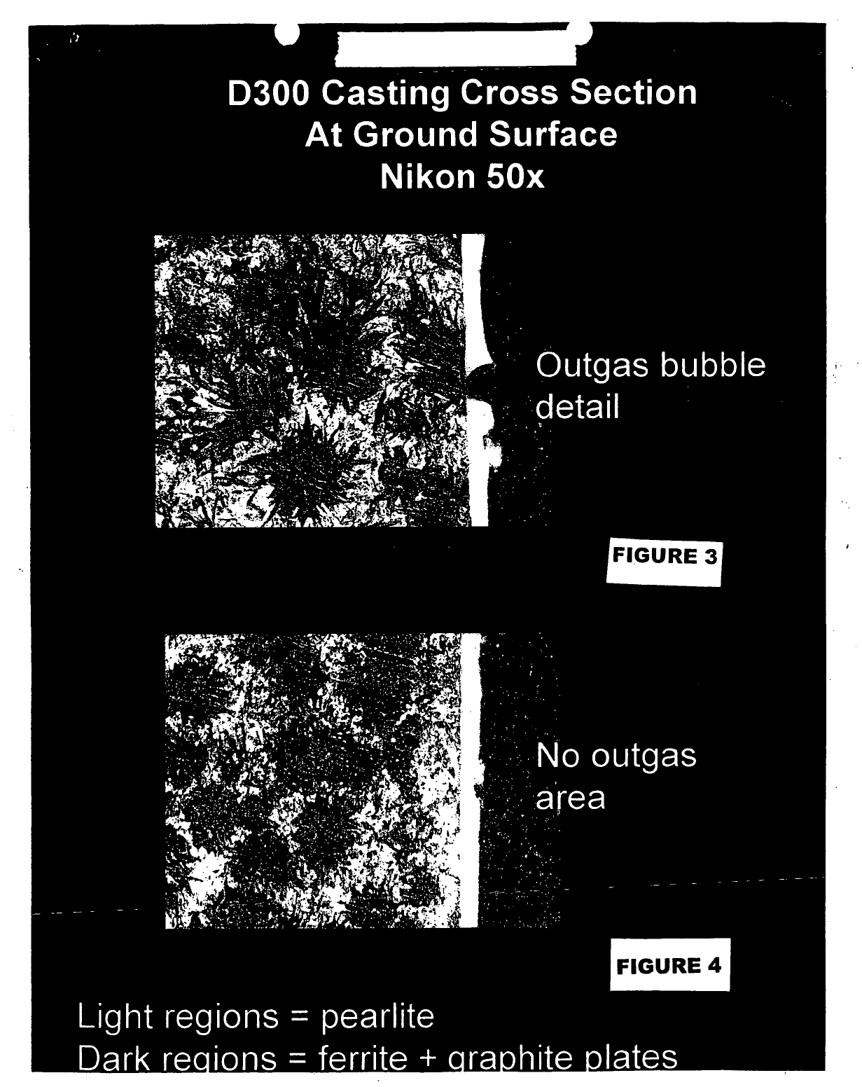

FIG. 4 is for purposes of comparison and illustrates that the coating has not been damaged from outgassing since the pearlite layer persists. It is to be noted that the region adjacent the coating is principally pearlite and the pearlite provides a protective boundary. By contrast, in FIG. 3 there is no pearlite next to the so-called outgas fissure. The pearlite thus is shown to provide a protective function.

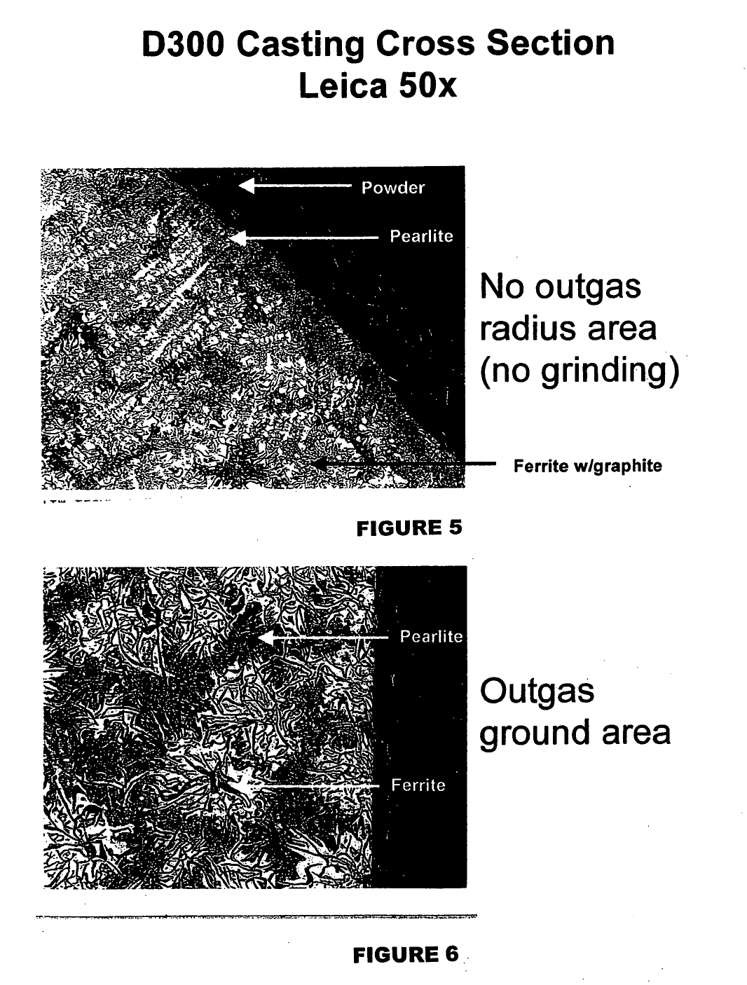

FIGS. 5 and 6 further depict the invention. The boundary layer of FIG. 5 includes pearlite. A powder coating is provided over the pearlite. The pearlite protects or fits over the ferrite interior of the casting.

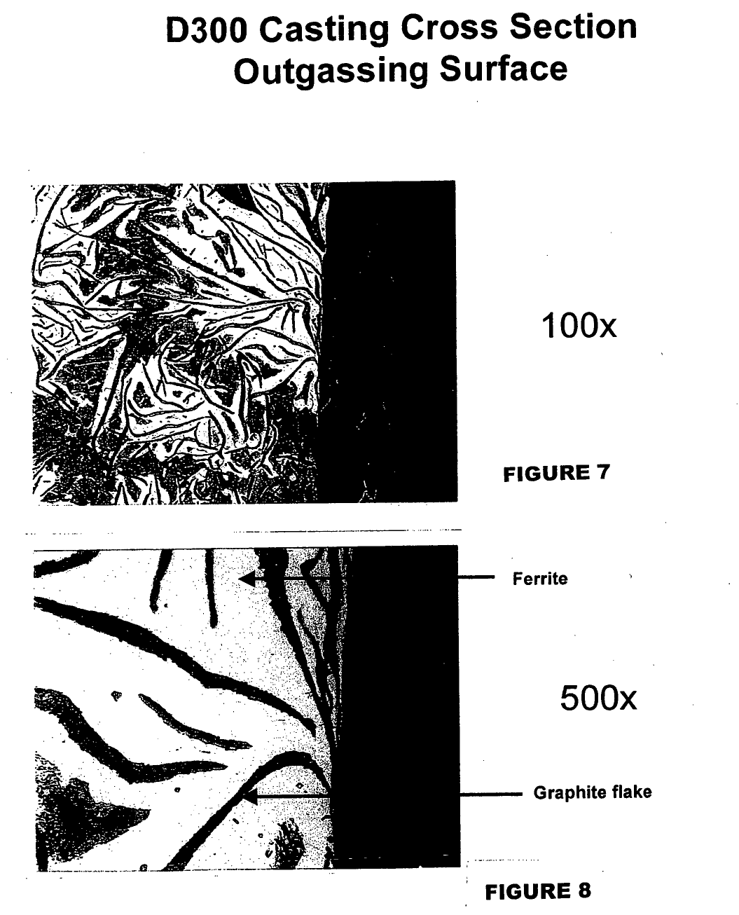

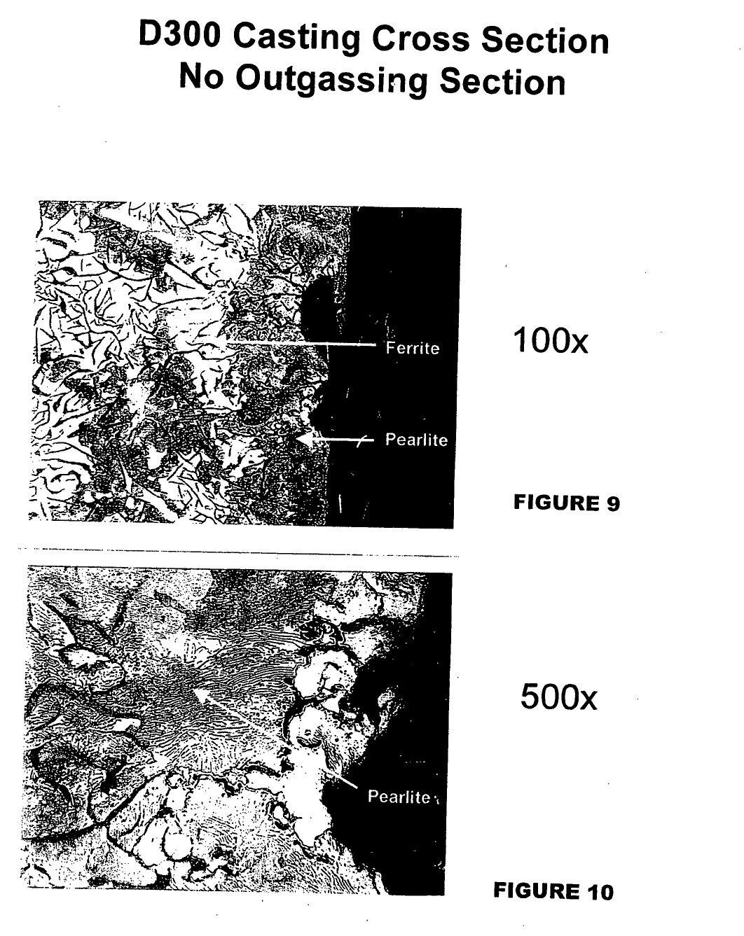

In FIG. 6 it will be noted that the pearlite does not provide a boundary layer inasmuch as there has been some grinding on the surface. As a result, outgassing may disrupt any coating material. FIG. 7 depicts the presence of a ferrite phase with graphite flakes near the work surface as does FIG. 8. FIGS. 9 and 10 illustrate the presence of pearlite on the surface of the casting with an interior section in the ferrite phase. The pearlite covers the ferrite phase and even though the pearlite surface includes some anomalies itself, the pearlite acts as a boundary layer precluding further outgassing and disruption of any powder coating placed over that boundary layer at the higher temperatures above about 200° F.

It has been found that the pearlite, which prevents outgassing, may be a generally homogeneous microstructure for the casting or may provide a boundary layer over a ferrite microstructure. The concept of using the pearlite derived from inoculating the cast iron melt with small weight fractions or weight percentages of copper is designed for application with respect to grey cast iron articles. However, the inclusion of copper in other types of cast irons may render a pearlite boundary layer which functions as described with respect to the grey cast iron. Thus, the invention should not be considered to be limited except by the following claims and equivalents thereof.

What is claimed is:

1. An article of manufacture comprising a polymeric powder coated grey cast iron article, said article comprising a grey cast iron substrate having a substantially pearlite microstructure at the surface of said article, said substrate surface coated with a polymeric powder.

2. An article of manufacture comprising a polymeric powder coated cast iron substrate including by weight percent about 0.40 to 1.50 copper wherein at least a layer of said cast iron at the coated surface of said substrate comprises a substantially pearlite microstructure and said surface is coated with a polymeric powder.

3. A coated cast iron article comprising in combination a grey cast iron substrate including impurities and the balance iron, said substrate comprising a generally pearlite microstructure at least at portions of the surface of substrate, said substrate coated at least in part with a coating applied at a temperature greater than about 200° F.

4. An article of manufacture comprising a cast iron alloy with a formulation in accord with ASTM specification 159 inoculated as a melt with about 0.40 to 1.50 weight percent copper, said cast iron alloy comprising a ferrite and pearlite or pearlite microstructure, said pearlite forming at least a part of a surface layer of said article characterized by reduced outgassing from the article when heated to a temperature greater than about 200° F.

5. The article of claim 4 wherein copper is included in the cast iron alloy in the range of about 0.40 to 0.75 weight percent.

6. The article of claim 4 including a silicate innoculant added to the melt in the range of about 0.20 to 0.40 weight percent.

7. The article of claim 4 wherein the cast article is heated for outgassing in the range of about 375-475° F. for a time less than about 90 minutes, subsequently cooled to less than about 250° F., powder coated with a polymeric powder and cooled to an ambient temperature to form a coated article of manufacture.

8. The article of claim 7 wherein the polymeric coating is in the range of at least about 10 mils in thickness.

9. The article of claim 4 wherein a copper silicate comprises the source of copper as an innoculant.

10. The article of claim 4 wherein the weight percent of copper is in the range of about 0.55 to 0.60±0.15 weight percent.

11. The article of claim 4 wherein the surface layer of substantially pearlite is at least about 3 mils in thickness.

12. A method for manufacture of a coated, grey cast iron article of manufacture, comprising the steps of:
(a) casting a melt of grey cast iron with at least a portion of said surface of the cast article having a generally pearlite microstructure;
(b) coating said article at a temperature greater than 200° F.; and
(c) cooling said coated article to ambient temperature.

13. The method of claim 12 wherein the coating step comprises coating the article at least in part with an organic powder at a temperature greater than 200° F.

14. A method for manufacture of an article of manufacture comprising the steps of forming a grey cast iron melt having an ASTM 159 constituent specification and including copper as an innoculant in the range of about 0.40 to 1.50 weight percent;
casting said melt to form an article having a surface layer consisting essentially of pearlite;
outgassing said article at a temperature greater than about 200° C. for a time not substantially longer than about 90 minutes, and cooling said article with an organic powder;
heating said coating to cure the coating; and
cooling the coated article to an ambient temperature.
